(19) United States
(12) Patent Application Publication
(10) Pub. No.: US 2012/0135262 A1
(43) Pub. Date: May 31, 2012

(54) METHOD OF MANUFACTURING FINE METAL POWDER AND FINE METAL POWDER MANUFACTURED BY USING THE SAME

(75) Inventors: Sung Kwon WI, Seoul (KR); Ji Hwan Shin, Yongin (KR); Jeong Min Cho, Seongnam (KR); Young Woo Lee, Suwon (KR)

(73) Assignee: SAMSUNG ELECTRO-MECHANICS CO., LTD.

(21) Appl. No.: 13/112,308

(22) Filed: May 20, 2011

(30) Foreign Application Priority Data
Nov. 25, 2010 (KR) 10-2010-0118172

(51) Int. Cl. B32B 5/16; B22F 9/04

(52) U.S. Cl. 428/570; 428/403; 75/356

(57) ABSTRACT

There are disclosed a method of manufacturing fine metal powder and fine metal powder manufactured by using the same. The method of manufacturing fine metal powder includes forming a pattern having a predetermined size and shape on a base substrate, forming a metal film on the pattern, and separating the metal film from the pattern to obtain individual metal particles having a predetermined size and shape. The fine metal powder manufactured by the method has a uniform shape and a uniform particle size distribution. The fine metal powder is in the form of flakes, having a large ratio of particle diameter to thickness.

### CROSS-REFERENCE TO RELATED APPLICATIONS

This application claims the priority of Korean Patent Application No. 10-2010-0118172 filed on Nov. 25, 2010, in the Korean Intellectual Property Office, the disclosure of which is incorporated herein by reference.

### BACKGROUND OF THE INVENTION

1. Field of the Invention

The present invention relates to a method of manufacturing fine metal powder and fine metal powder manufactured by using the same, and more particularly, to a method of manufacturing fine metal powder in the form of flakes, having a uniform particle size distribution and fine metal powder manufactured by using the same.

2. Description of the Related Art

As electronic products have become highly functional and miniaturized, various electronic components and materials used for the electronic products have rapidly become lighter and thinner, while also becoming shorter and smaller. In the case of a conductive electrode material, which is an essential material for forming electronic components and electric circuits, the demand for electrode materials having superior electrode connectivity and conductivity, while allowing electrodes to remain thin, has been increasing.

In particular, an internal electrode used for a chip component requiring co-firing with a ceramic may have a defect, in that the electrode connectivity thereof may be deteriorated, depending on the level of thinning and thickening of a ceramic layer. Due to a difference in shrinkage rates between the ceramic and the electrode material during the co-firing with the ceramic, the internal electrode may have limitations, in that internal defects may be increased and electrode connectivity may be deteriorated, thereby leading to a degradation of the capacitance characteristics thereof.

Recently, in order to realize a high functional electronic component, an attempt to replace spherical metal powder which has been used as a main intergradient of the conductive electrode material in the related art, with metal powder having the form of flakes has been proceeding. The use of the metal powder in the form of flakes is intended to improve the function of the electronic component by controlling the sintering shrinkage rate of the electrode and the thinning of an internal electrode layer.

The spherical metal powder has been manufactured by a wet method, a vapor method, or the like. In particular, the spherical metal powder used for the electrode material has been manufactured by using a liquid reduction method, a hydrothermal method, an electrochemical method, a chemical vapor deposition (CVD) method, a RF-plasma method or the like.

As metal powder particles have become finer, controlling the size and particle size distribution thereof has increased in difficulty. In addition, in the case in which particulate metal powder is used as the electrode material, a decrease in sintering temperature and rapid sintering shrinkage may occur during co-firing with a ceramic material. In order to solve these limitations, the method of dispersing particulate ceramic powder capable of giving sintering delay within the electrode, or coating the surfaces of metal particles has been reviewed.

In addition, as described above, when the metal powder in the form of flakes is used, an electrode layer may be thinner and electrode connectivity of the electrode may be improved.

The metal powder in the form of flakes is manufactured by a mechanical grinding method through a milling process. In the milling process, the spherical metal powder having a regular particle size distribution may be modified to be metal powder in the form of flakes, by mechanical energy applied thereto. However, the metal powder in the form of flakes manufactured by the milling process has a non-uniform shape and size and there are limitations in forming a large aspect ratio thereof.

### SUMMARY OF THE INVENTION

An aspect of the present invention provides a method of manufacturing fine metal powder in the form of flakes, having a uniform particle size distribution and fine metal powder manufactured by using the same.

According to an aspect of the present invention, there is provided a method of manufacturing fine metal powder, including: forming a pattern having a predetermined size and shape on a base substrate; forming a metal film on the pattern; and separating the metal film from the pattern to obtain individual metal particles having a predetermined size and shape.

The manufacturing method may further include forming a strip layer on the pattern prior to the forming of the metal film.

The strip layer may be formed to have a thickness thicker than that of the metal film. The strip layer may be made of a material having low reactivity with the metal film, without deforming the pattern of the base substrate.

The strip layer may be formed of a polymeric material.

The separating of the metal film may be performed by removing the strip layer through the use of a solvent in which the strip layer is to be dissolved.

The manufacturing method may further include forming a strip layer on the metal film and forming the metal film on the strip layer. Here, the forming of the strip layer and the forming of the metal film may be performed once or more. The manufacturing method may further include forming one or more other metal films on the metal film in order that the individual metal particles have a multilayer structure. The manufacturing method may further include forming a metal oxide layer on the metal film in order that the individual metal particles have a multilayer structure.

The base substrate may be made of a glass or a polymeric material. The pattern may be configured to have recess portions having a predetermined size and shape and projection portions having a predetermined size and shape.

The fine metal powder may be manufactured in such a manner as to allow a particle size distribution thereof to be in the range of ±20% of a mean particle diameter D₅₀.

The metal particles may have a ratio of particle diameter to thickness (particle diameter/thickness) in the range of 20 to 100.

According to another aspect of the present invention, there is provided fine metal powder, including metal particles having a predetermined size and shape, and having a particle size distribution in the range of ±20% of a mean particle diameter D₅₀.

The metal particles may have a ratio of particle diameter to thickness (particle diameter/thickness) in the range of 20 to 100.

The metal particles may have a particle diameter in the range of 1 to 10 μm.

The metal particles may have a thickness in the range of 10 to 100 nm.

The metal particles may have a polygonal shape or a round shape.

The metal particles may have a multilayer structure in which a plurality of metal layers are stacked.

The metal particles may have a multilayer structure in which a plurality of metal layers and a plurality of metal oxide layers are stacked.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view schematically showing fine metal powder according to an exemplary embodiment of the present invention;

FIG. 2 is a scanning electron microphotograph (SEM) showing fine metal powder according to an exemplary embodiment of the present invention;

FIG. 3 is a perspective view schematically showing fine metal powder according to another exemplary embodiment of the present invention;

FIG. 4 is a perspective view schematically showing fine metal powder according to another exemplary embodiment of the present invention;

FIGS. 5A through FIG. 5C individually show a cross sectional view of a process for explaining a method of manufacturing fine metal powder according to an exemplary embodiment of the present invention; and

FIG. 6 shows a cross sectional view of a process for explaining a method of manufacturing fine metal powder according to another exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and sizes of elements may be exaggerated for clarity. Like reference numerals in the drawings denote like elements.

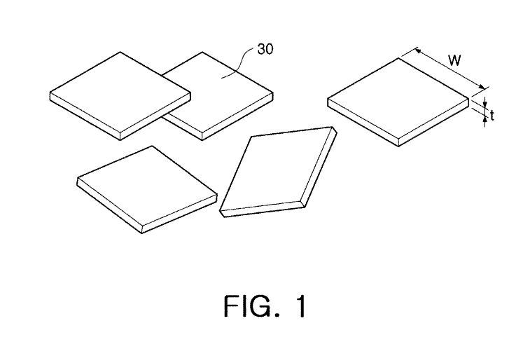

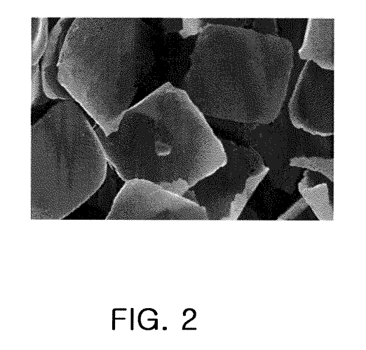

FIG. 1 is a perspective view schematically showing fine metal powder according to an exemplary embodiment of the present invention. FIG. 2 is a scanning electron microphotograph (SEM) showing fine metal powder according to the exemplary embodiment of the present invention.

Referring to FIG. 1 and FIG. 2, fine metal powder according to the exemplary embodiment may be formed of thin metal particles 30 in the form of flakes.

In the exemplary embodiment, the metal particles 30 are illustrated as having a rectangular shape. However, the present invention is not limited thereto and the metal particles 30 may be formed to have various shapes, for example, circular, polygonal, or the like.

According to the exemplary embodiment, the fine metal powder is formed by collecting the metal particles 30 having a predetermined size and shape. The metal particles forming the fine metal powder have a uniform shape and size. Amore detailed explanation with regard to this will be described, in a method of manufacturing fine metal powder, to be described later.

In the exemplary embodiment, a particle diameter w of metal particles 30 may be 1 to 10 μm. The particle diameter of each metal particle 30 may be based on the longest length of a surface thereof having a maximum surface area.

The metal particles 30 may be in the form of flakes, having a large ratio of particle diameter w to thickness t. The ratio w/t of particle diameter to thickness may be 20 to 100. The thickness t of the metal particles 30 may be 10 to 100 nm.

According to the present invention, the size of the metal particles may be controlled, thereby allowing the particle size distribution of the fine metal powder to be uniformly performed. According to the exemplary embodiment, the particle size distribution of the fine metal powder may be in the range of ±20% of a mean particle diameter D₅₀. The mean particle diameter D₅₀ of the fine metal powder may be 1 to 10 μl.

The fine metal powder according to the exemplary embodiment may be Ni, Cu, Ag, Au, Al or the like.

The fine metal powder according to the exemplary embodiment may be used for manufacturing a conductive paste. The conductive paste may be used for the wiring material of an electronic circuit, or for an electromagnetic shielding material. In addition, the conductive paste may be used for an internal electrode, in a multilayer ceramic capacitor (MLCC), a multilayer ceramic inductor, or the like.

The fine metal powder according to the exemplary embodiment may be in the form of flakes, so that conductivity of the electrode using the fine metal powder may be not degraded and connectivity thereof may be higher. Moreover, when the fine metal powder is applied to an electronic component requiring co-firing with a ceramic layer, a thin electrode layer may be formed and sintering shrinkage may be controlled to thereby allowing the capacity of the electronic component to be secured.

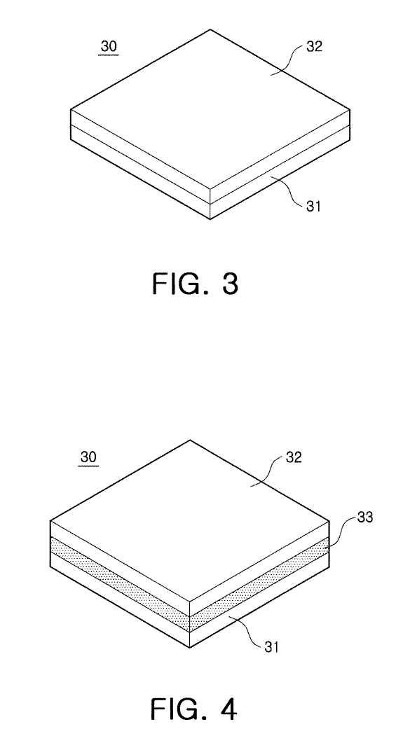

FIG. 3 is a perspective view schematically showing fine metal powder according to another embodiment of the present invention. Different components from the above-mentioned embodiment will be explained in focus, and a detailed description about the same components will be omitted.

Referring to FIG. 3, the metal particles may have a multilayer structure in which a plurality of metal layers are stacked and include a first metal layer 31 and a second metal layer 32 stacked on the first metal layer 31.

FIG. 3 illustrates a structure in which two metal layers are stacked. However, the present invention is not limited thereto, and a structure in which two or more layers are stacked may be used.

The first metal layer 31 or the second metal layer 32 may be formed of a metal, such as Ni, Cu, Ag, Au, Al, or the like.

The first metal layer 31 and the second metal layer 32 may be formed of different metals. Each metal layer may be formed of an alloy including one or more metals.

As aforementioned, the fine metal powder according to the exemplary embodiment is formed by collecting the metal particles 30 having a predetermined size and shape. The metal particles forming the fine metal powder have a uniform shape and size.

According to the exemplary embodiment, the particle size distribution of the fine metal powder may be in the range of ±20% of the mean particle diameter D₅₀. The mean particle diameter D₅₀ of the fine metal powder may be 1 to 10 μm.

In the exemplary embodiment, the particle diameter of the metal particles 30 may be 1 to 10 μl. Each thickness of the first metal layer 31 and the second metal layer 32 may be 1 to 100 μm. The thicknesses of the first metal layer 31 and the second metal layer 32 may be adjusted, thereby allowing the ratio of particle diameter to thickness (particle diameter/thickness) of the metal particles to be adjusted. The ratio of particle diameter to thickness (particle diameter/thickness) of the metal particles may be 20 to 100.

FIG. 4 is a perspective view schematically showing fine metal powder according to another exemplary embodiment of the present invention. Different components from the above-mentioned embodiments will be explained in focus, and a detailed description about the same components will be omitted.

Referring to FIG. 4, the metal particles 30 may have a multilayer structure and include the first layer 31, a metal oxide layer 33 stacked on the first metal layer 31, and the second metal layer 32 stacked on the metal oxide layer 33.

FIG. 4 illustrates a structure in which two metal layers and one metal oxide layer are stacked. However, the present invention is not limited thereto, and a structure in which two metal layers and two or more metal oxide layers are stacked may be used. The order of stacking the metal layers and the metal oxide layer is not specifically limited. The multilayer structure of the metal particles may be properly adjusted depending on a required function.

As stated above, the first metal layer 31 or the second metal layer 32 may be formed of a metal, such as Ni, Cu, Ag, Au, Al, or the like.

In the exemplary embodiment, the particle diameter of the metal particles 30 may be 1 to 10 μm. Each thickness of the first metal layer 31, the second metal layer 32, and the metal oxide layer 33 may be 10 to 100 nm. The thicknesses of the first metal layer 31, the second metal layer 32, and the metal oxide layer 33 may be adjusted, thereby allowing the ratio of particle diameter to thickness of the metal particles to be adjusted. The ratio of particle diameter to thickness (particle diameter/thickness) of the metal particles may be 20 to 100.

Hereafter, a method of manufacturing fine metal powder according to an exemplary embodiment of the present invention will be explained. The constitution of the fine metal powder will be also more clarified from following descriptions concerning the method of manufacturing the fine metal powder.

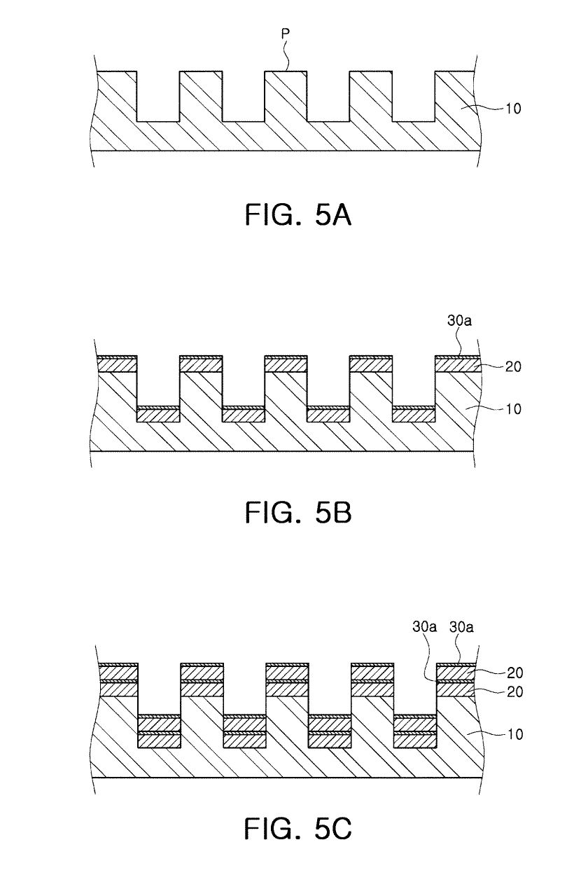

FIGS. 5A through 5C individually show a cross sectional view of a process for explaining a method of manufacturing fine metal powder according to an exemplary embodiment of the present invention.

First of all, a pattern P having a predetermined size and shape may be formed on a base substrate 10, as shown in FIG. 5A.

The base substrate 10 is not specifically limited, as long as it is a material facilitating the formation of the pattern. For example, a glass or polymeric material may be used as the base substrate.

As the polymeric material, polyethylene terephthalate (PET), polycarbonate (PC), polypropylene (PP), or the like may be used; however, the polymeric material is not limited thereto.

A method of forming the pattern P on the base substrate 10 is not specifically limited and may be properly selected depending on the material of the base substrate. For example, optical lithography and photolithography processes using a photosensitive resin may be used. A nano imprint Lithography (NIL) process using an ultraviolet curable resin or a thermosetting resin may be also used.

The pattern P may be formed on the base substrate by using a gravure printing process, a chemical etching process, a mechanical machining process, or the like.

In the exemplary embodiment, the pattern P of the base substrate is configured in such a manner that recess portions and projection portions are alternatively disposed. According to the exemplary embodiment, each of the recess portions and projection portions has a predetermined shape and size. By using the upper surfaces of both of the recess portions and projection portions, fine metal powder having a predetermined shape and size may be manufactured.

In order to increase the manufacturing yield of the fine metal powder, the percentage of efficient pattern formation may be high. An efficient pattern refers to a portion, in which a metal film is formed, and then through the subsequent separation of the metal film, metal particles are formed. In order to increase the percentage of efficient pattern formation, a distance between effective patterns may be narrowed, or the effective patterns may be formed as the recess portions and projection portions as shown in the exemplary embodiment. Also, the patterns may be formed on the both surfaces of the base substrate.

Next, a strip layer 20 may be formed on the pattern P of the base substrate as shown in FIG. 5B.

Without forming the strip layer 20, a metal film 30a may be formed on the pattern P of the base substrate 10. However, in the case of forming the strip layer 20, the metal film 30a may be more easily separated.

The strip layer 20 is not specifically limited; however, it may be formed as a material having little or no reactivity with the metal film 30a, without deforming the pattern of the base substrate. In addition, the strip layer 20 may be formed as an easily removable material.

The strip layer 20 may be formed as the polymeric material; however, it is not limited thereto. As the polymeric material, a material easily removable in a specific solvent, for example, ethylcellulose or the like may be used. However, the polymeric material is not limited thereto.

Ethylcellulose has a characteristic capable of easily dissolving in solvents, for example, alcohol, such as isopropyl alcohol (IPA) or the like, and ketone, such as acetone, methyl ethyl ketone (MEK) or the like.

In addition, the strip layer 20 may use a water soluble resin, such as polyvinyl alcohol (PVA).

Moreover, the strip layer 20 may use a phenolic resins, such as a polyvinyl butyral (PVB), a polystyrene (PS), an acrylic resin, a novolac resin, or the like.

The strip layer 20 may be formed by applying a solution in which the polymeric material is dissolved, to the base substrate. As the solvent of the solution, a material which does not deform the pattern P formed on the base substrate 10, while easily dissolving the polymeric material, may be used.

In an exemplary embodiment of the present invention, a method of forming a polymeric solution may be properly selected according to the material property of the polymeric solution or the shape and characteristic of the pattern P. For example, when the viscosity of the polymeric solution is relatively low and the pattern P of the base substrate is formed to have a small size, a spray coating method may be used; however, the present invention is not limited thereto. In this case, optimized numerical values concerning variables, for example, the size, pressure, air pressure and the like of a spray nozzle, together with the drying characteristic of the polymeric solution may be experimentally derived. Then, through the utilization of the optimized numerical values, the strip layer 20 having a uniform thickness may be formed.

In addition, the formation of the strip layer 20 may be performed by using various application methods, such a transfer type application method using a micro-gravure process, or a contact type application method using a bar-coater, a roller, or the like.

The thickness of the strip layer 20 may be properly adjusted depending on the size of a metal particle to be manufactured. The thickness of the strip layer may be thicker than that of the metal film 30a to be formed.

For example, the thickness of the strip layer 20 may be 0.1 to 1 μm. In the case in which the thickness of the strip layer is too thin, the removal of the strip layer may be difficult due to the difficulty of solvent penetration. In addition, in the case in which the thickness of the strip layer is too thick, an excessive amount of time and energy may be consumed for the removal of the strip layer, thereby causing the metal film to be damaged.

Next, as shown in FIG. 5B, the metal film 30a is formed on the strip layer 20.

A method of forming the metal film 30a is not specifically limited, and the forming of the metal film 30a may be performed by a method well known in the art.

For example, a thermal evaporation method, an e-beam deposition method, or a physical vapor deposition method, such as a sputtering method or the like may be used; however, the present invention is not limited thereto.

In addition, after forming a metal seed layer on the strip layer 20 by the sputtering method, the metal film 30a having a desirable thickness may be formed by performing an electroplating process, based on this metal seed layer. This electroplating process may be used to form a thicker metal film.

In an exemplary embodiment of the present invention, the metal film 30a may be formed to have a thickness of 10 to 100 nm.

Hereafter, the metal film is separated from the pattern of the base substrate, and individual metal particles having a predetermined size and shape corresponding to the shape and size of the pattern may be obtained. The obtaining of the metal particles may be performed by the removal of the strip layer, and a detailed description thereof will be explained later.

According to another embodiment of the present invention, the process of forming the metal film 30a and the strip layer 20 may be performed once more, as shown in FIG. 5C. The method of forming the strip layer and the metal film is as aforementioned.

The number and order of the process of forming the metal film and the strip layer are not specifically limited. When the process of forming the metal film and the strip layer is repetitively performed, a greater number of metal particles may be manufactured at once.

According to an exemplary embodiment of the present invention, the metal film 30a may be separated from the pattern P of the base substrate 10, thereby allowing the individual metal particles to be obtained. When the strip layer is formed, the individual metal particles may be obtained by removing the strip layer 20 formed between the base substrate 10 and the metal film 30a.

More particularly, the strip layer 20 may be removed by using a specific solvent capable of easily dissolving the strip layer 20.

For example, when ethylcellulose is used as the strip layer, the ethylcellulose may exhibit superior solubility in ethanol, toluene, or a mixed solvent thereof. Thus, when the base substrate is immersed in this solvent, the strip layer 20 formed of the ethylcellulose may be easily dissolved, so that the metal film 30a is separated therefrom, thereby allowing the individual metal particles 30 to be obtained, as shown in FIG. 1.

When the strip layer is not formed, the metal film is separated from the pattern of the base substrate, thereby allowing the individual metal particles to be obtained.

According to the exemplary embodiment of the present invention, the individual metal particles having a predetermined size and shape corresponding to the shape and size of the pattern may be obtained. In addition, a plurality of metal particles having a uniform shape and size may be easily manufactured.

Moreover, since the shape and size of the pattern may be easily adjusted, the metal particle may be easily manufactured according to a designed shape and size.

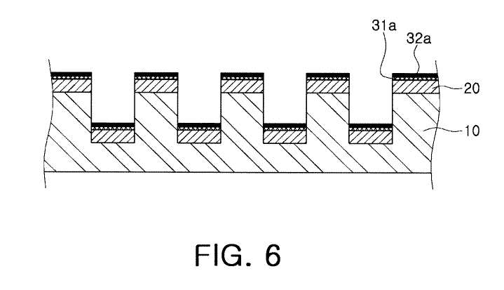

FIG. 6 is a cross sectional view of a process for explaining a method of manufacturing fine metal powder according to another exemplary embodiment of the present invention. Different components from the above-mentioned embodiment will be explained in focus, and a detailed description about the same components will be omitted.

FIG. 6 may be understood as a process subsequent to FIG. 5B. The metal film 30a shown in FIG. 5B may be understood as a first metal film 31a in this exemplary embodiment. After forming the first metal film 31a, a second metal film 32a may be formed on the first metal film 31a. A method of forming the second metal film 32a may use the above mentioned method of forming the metal film.

Moreover, while not illustrated, through the additional formation of one or more metal films on the second metal film, the metal particles of a multilayer structure having two or more layers may be manufactured.

Hereafter, as mentioned above, the first metal film 31a and the second metal film 32a are separated from the pattern of the base substrate, thereby allowing the individual metal particles 30 having the first metal layer 31 and the second metal layer 32 to be obtained, as shown in FIG. 3.

Furthermore, while not illustrated, the metal oxide layer and the second metal film may be formed on the first metal film.

Hereafter, the first metal film and the second metal film are separated from the pattern of the base substrate, so that the individual metal particles 30 of the multilayer structure having the first metal layer 31, the metal oxide layer 33 and the second metal layer 32 may be obtained, as shown in FIG. 4.

The number of repetition and the formation order of the metal film and the metal oxide layer are not limited, and by adjusting these, the multilayer structure of the metal particles may be diversified.

The fine metal powder manufactured by the above methods may be variously used.

For example, the conductive paste may be manufactured by mixing the fine metal powder produced according to an exemplary embodiment of the present invention, a resin binder, and an organic solvent.

In this case, as the resin binder, an alkyd resin, ethylcellulose, or the like, which is an organic compound easily removed during a firing process may be used. As the organic solvent, terpineol, butyl carbitol acetate, kerosene, or the like, which is an organic compound giving the paste a proper viscosity and being easily volatilized by a dry treatment after being applied to a green sheet may be used.

The conductive paste manufactured in this manner may be used to form the wiring of the electronic circuit and the electrode of electronic devices (for example, MLCC, MLCI).

As set forth above, the fine metal powder according to exemplary embodiments of the invention has a uniform shape and a uniform particle size distribution. The fine metal powder is in the form of flakes, having a large ratio of particle diameter to thickness. Thus, when the conductive paste and the electromagnetic shielding material are manufactured by using the fine metal powder, an electrode film having high electrode connectivity may be formed. Accordingly, in the multilayer ceramic capacitor and the multilayer ceramic inductor requiring the co-firing, an internal electrode thereof can be formed thinner. Moreover, the degradation of the electrode connectivity due to high temperature shrinkage may be minimized.

In the method of manufacturing fine metal powder according to exemplary embodiments of the invention, the fine metal powder is formed by using the pattern so that the shape and size of the fine metal powder may be easily controlled. Accordingly, metal powder having a specific shape can be also manufactured.

In addition, by using the method of separating the individual metal particles from the pattern, the size and shape of the metal particles may be uniformly formed, without causing the formation of a metal particle cluster or agglomerate.

While the present invention has been shown and described in connection with the exemplary embodiments, it will be apparent to those skilled in the art that modifications and variations can be made without departing from the spirit and scope of the invention as defined by the appended claims.

What is claimed is:

1. A method of manufacturing fine metal powder, the method comprising:
forming a pattern having a predetermined size and shape on a base substrate;
forming a metal film on the pattern; and
separating the metal film from the pattern to obtain individual metal particles having a predetermined size and shape.

2. The method of claim 1, further comprising forming a strip layer on the pattern prior to the forming of the metal film.

3. The method of claim 2, wherein the strip layer is formed to have a thickness thicker than that of the metal film.

4. The method of claim 2, wherein the strip layer is made of a material having low reactivity with the metal film, without deforming the pattern of the base substrate.

5. The method of claim 2, wherein the strip layer is formed of a polymeric material.

6. The method of claim 2, wherein the separating of the metal film is performed by removing the strip layer through the use of a solvent in which the strip layer is to be dissolved.

7. The method of claim 1, further comprising forming a strip layer on the metal film and forming the metal film on the strip layer, wherein the forming of the strip layer and the forming of the metal film are performed once or more.

8. The method of claim 1, further comprising forming one or more other metal films on the metal film in order that the individual metal particles have a multilayer structure.

9. The method of claim 1, further comprising forming a metal oxide layer on the metal film in order that the individual metal particles have a multilayer structure.

10. The method of claim 1, wherein the base substrate is made of a glass or a polymeric material.

11. The method of claim 1, wherein the pattern is configured to have recess portions having a predetermined size and shape and projection portions having a predetermined size and shape.

12. The method of claim 1, wherein the fine metal powder is manufactured in such a manner as to allow a particle size distribution thereof to be in a range of ±20% of a mean particle diameter D₅₀.

13. The method of claim 1, wherein the metal particles have a ratio of particle diameter to thickness (particle diameter/thickness) in a range of 20 to 100.

14. Fine metal powder comprising: metal particles having a predetermined size and shape, and having a particle size distribution in a range of ±20% of a mean particle diameter D₅₀.

15. The fine metal powder of claim 14, wherein the metal particles have a ratio of particle diameter to thickness (particle diameter/thickness) in a range of 20 to 100.

16. The fine metal powder of claim 14, wherein the metal particles have a particle diameter in a range of 1 to 10 μm.

17. The fine metal powder of claim 14, wherein the metal particles have a thickness in a range of 10 to 100 nm.

18. The fine metal powder of claim 14, wherein the metal particles have a polygonal shape or a round shape.

19. The fine metal powder of claim 14, wherein the metal particles have a multilayer structure in which a plurality of metal layers are stacked.

20. The fine metal powder of claim 14, wherein the metal particles have a multilayer structure in which a plurality of metal layers and a plurality of metal oxide layers are stacked.
